(19) United States
(12) Patent Application Publication
(10) Pub. No.: US 2007/0220257 A1
(43) Pub. Date: Sep. 20, 2007

(54) Controlled-Access Recording Generator

(75) Inventors: Eitan Mardiks, Ra'anana (IL); Ishay Pomerantz, Kefar Saba (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: SanDisk IL Ltd., Kfar Saba (IL)

(21) Appl. No.: 11/681,792

(22) Filed: Mar. 5, 2007

Related U.S. Application Data
(60) Provisional application No. 60/779,319, filed on Mar. 6, 2006.

(51) Int. Cl. H04L 9/00

(52) U.S. Cl. 713/173

(57) ABSTRACT

A recording system for securely recording an event, the system including: a capturing device for an owner to capture signals from the event, and for converting the signals into digital data; a public-key encrypting mechanism, configured to use a public key of an asymmetric key-pair, for encrypting the data into encrypted data; a non-volatile storage device for storing the encrypted data; and a private-key decrypting mechanism, configured to use a private key of the asymmetric key-pair, for decrypting the encrypted data stored in the storage device only upon using the private key, wherein the private key is securely maintained with a trusted private-key holder, and wherein the trusted private-key holder is at least one entity other than the owner of the capturing device. Preferably, the trusted private-key holder is operative to decrypt the encrypted data only upon receiving an authorization from an authorized entity.

This patent application claims the benefit of U.S. Provisional Patent Application No. 60/779,319 filed Mar. 6, 2006.

### FIELD AND BACKGROUND OF THE INVENTION

The present invention relates to systems and methods for recording an event in such a way that playing the recorded event is restricted by an external authority other than the owner of the recording.

Digital recording of images, audio, and video is well-known in the art of digital communication as a means to keep a physical record of an event. Digital recorders, such as cameras, audio recorders, and video recorders are well-known in the art, and they all create a digital representation of the recorded event.

In some applications, privacy, security, or legal considerations dictate that the recorded event be maintained, or delivered, confidentially. Prior-art recording equipment is often equipped with a means for encryption of data while the data is being recorded or transferred, limiting data access to authorized individuals only. For example, a TV program may be encrypted while being recorded and/or broadcast as a part of a digital rights-management (DRM) system that limits consumption of digital content to paying subscribers Such systems are available from NDS Corporation, Jerusalem, Israel. Another prior-art example is described in Blair and Gill, U.S. Patent Application No. 20060123106, which recites a system for monitoring communication traffic, and storing the traffic in an encrypted format in order to restrict availability.

Common to all prior-art protected recorders, the owner of the recording media who has made the recording (either directly or by assignment to an operator), is authorized and able to play the recorded event. The basic assumption is that if such an individual is allowed to attend and record the event, then he/she is also allowed to view or hear the same event from a recording.

However, there are legal situations in which an individual is legally allowed to attend and participate in an event, and yet, he/she is not legally allowed to make a recording of that event. The most well-known example of such a situation is the recording of a phone conversation. In some countries, it is against the law to record a conversation without obtaining consent from the other party. If the recording is being made by a third party, who is not part of the conversation, such a recording is prohibited by law in many countries.

It would be desirable for people who need to provide evidence (e.g. an alibi, an incrimination, a priority date, and other commercial evidence) to be able to record relevant events without committing a breach of law by assuring that confidentiality and privacy of the recording remain intact.

### SUMMARY OF THE INVENTION

It is the purpose of the present invention to provide systems and methods for recording an event in such a way that playing the recorded event is restricted by an external authority other than the owner of the recording.

For the purpose of clarity, several terms which follow are specifically defined for use within this application. The term “event” is used in this application to refer to a real-life process involving sounds and/or scenes that can be witnessed by a person, and that can be at least partially recorded by an electronic recorder. The term “event recorder” is used in this application to refer to an electronic device capable of producing a recording of an event. The term “event player” is used in this application to refer to an electronic device capable of playing the recorded sounds and/or images of a recorded event from the recording of an event recorder.

The term “encrypting event recorder” is used in this application to refer to an event recorder that produces a encrypted recording of an event, where the encrypted recording cannot be played by a regular event player. The term “decrypting event player” is used in this application to refer to an electronic device capable of playing recordings from a encrypting event recorder. The terms “one-way recording device”, “write-only recorder”, and “WOR” are used in this application to refer to a device that can be used to record events, but cannot be used to play recorded events.

The term “trusted private-key holder” is used in this application to refer to an external authority that maintains the security of private keys of asymmetric-key pairs (used in a public-key encrypting system, for example). The term “authorized entity” is used in this application to refer to an authority that has jurisdiction to order encrypted media to be decrypted by a trusted private-key holder.

The present invention utilizes real-time encryption of a recorded event, where the encryption key is automatically generated, and asymmetrically-encrypted using a public key maintained by a trusted private-key holder. The only way to play the recorded media is by using a matching private key, which is kept secure by the trusted private-key holder. The trusted private-key holder is trusted not to release the private key. Thus, the use of the private key to play the recorded event can only occur if the trusted private-key holder is instructed to do so by a court order (or in keeping with any other agreement between the recording party of the event and the recorded party in the event) by an authorized entity.

In order to ensure that the recording device is only capable of recording encrypted data, the recording device needs to be approved, stamped, and/or sealed by a trusted authority as a secure, “one-way” recording device. If the recording device is integrated into a communication device (e.g. mobile phone), the communication device needs to be verified. On way to verify the communication device is by sending a unique device ID to a service provider or network operator that is entrusted with such device verification. This trusted party then sends a certificate approving the authenticity of the communication device as having a secure, one-way recording device.

Therefore, according to the present invention, there is provided for the first time a recording system for securely recording an event, the system including: (a) a capturing device for an owner to capture signals from the event, and for converting the signals into digital data; (b) a public-key encrypting mechanism, configured to use a public key of an asymmetric key-pair, for encrypting the data into encrypted data; (c) a non-volatile storage device for storing the encrypted data; and (d) a private-key decrypting mechanism, configured to use a private key of the asymmetric key-pair, for decrypting the encrypted data stored in the storage device only upon using the private key, wherein the private key is securely maintained with a trusted private-key holder, and wherein the trusted private-key holder is at least one entity other than the owner of the capturing device.

Preferably, the capturing device includes at least one device selected from the group consisting of: a camera, a microphone, a video recorder, and an audio recorder.

Preferably, the public key is provided by the trusted private-key holder to the encrypting mechanism.

Preferably, the trusted private-key holder is operative to decrypt the encrypted data only upon receiving an authorization from an authorized entity.

Most preferably, the trusted private-key holder is operative to re-encrypt the encrypted data, after being decrypted using the private key, and to provide re-encrypted data and an authorized-entity key to the authorized-entity.

Most preferably, the authorized entity is at least one entity other than the owner of the capturing device.

Preferably, the storage device is a flash memory device.

Preferably, the capturing device, the encrypting mechanism, and the storage device are housed in a single housing.

According to the present invention, there is provided for the first time a method for securely recording an event, the method including the steps of: (a) capturing signals from the event in a capturing device by an owner; (b) converting the signals to digital data in the capturing device; (c) encrypting the data using a public-key encrypting mechanism, configured to use a public key of an asymmetric key-pair, for encrypting the data into encrypted data; (d) storing the data after encryption in a storage device; and (e) decrypting the data, using a private-key decrypting mechanism, configured to use a private key of the asymmetric key-pair, for decrypting the encrypted data stored in the storage device only upon using the private key, wherein the private key is securely maintained with a trusted private-key holder, and wherein the trusted private-key holder is at least one entity other than the owner of the capturing device.

Preferably, the capturing device includes at least one device selected from the group consisting of: a camera, a microphone, a video recorder, and an audio recorder.

Preferably, the public key is provided by the trusted private-key holder to the encrypting mechanism.

Preferably, the trusted private-key holder is operative to decrypt the encrypted data only upon receiving an authorization from an authorized entity.

Most preferably, the trusted private-key holder is operative to re-encrypt the encrypted data, after being decrypted using the private key, and to provide re-encrypted data and an authorized-entity key to the authorized-entity.

Most preferably, the authorized entity is at least one entity other than the owner of the capturing device.

Preferably, the storage device is a flash memory device.

Preferably, the capturing device, the encrypting mechanism, and the storage device are housed in a single housing.

These and further embodiments will be apparent from the detailed description and examples that follow.

### BRIEF DESCRIPTION OF THE DRAWINGS

The present invention is herein described, by way of example only, with reference to the accompanying drawings, wherein:

FIG. 1A is a schematic block diagram of a typical prior-art event recorder with no encryption mechanism;

FIG. 1B is a schematic block diagram of a typical prior-art event recorder using a symmetric key for encryption of the recorded event;

FIG. 1C is a schematic block diagram of a one-way event recorder using asymmetric keys for encryption of the recorded event, according to a preferred embodiment of the present invention;

FIG. 2 is a simplified flowchart of the process of recording a write-only recorder (WOR) recorded event, according to a preferred embodiment of the present invention;

FIG. 3 is a simplified flowchart of the process of playing a WOR-recorded event, according to a preferred embodiment of the present invention.

### DESCRIPTION OF THE PREFERRED EMBODIMENTS

The present invention relates to systems and methods for recording an event in such a way that playing the recorded event is restricted by an external authority other than the owner of the recording. The principles and operation for recording an event in such a way that playing the recorded event is restricted by an external authority, according to the present invention, may be better understood with reference to the accompanying description and the drawings.

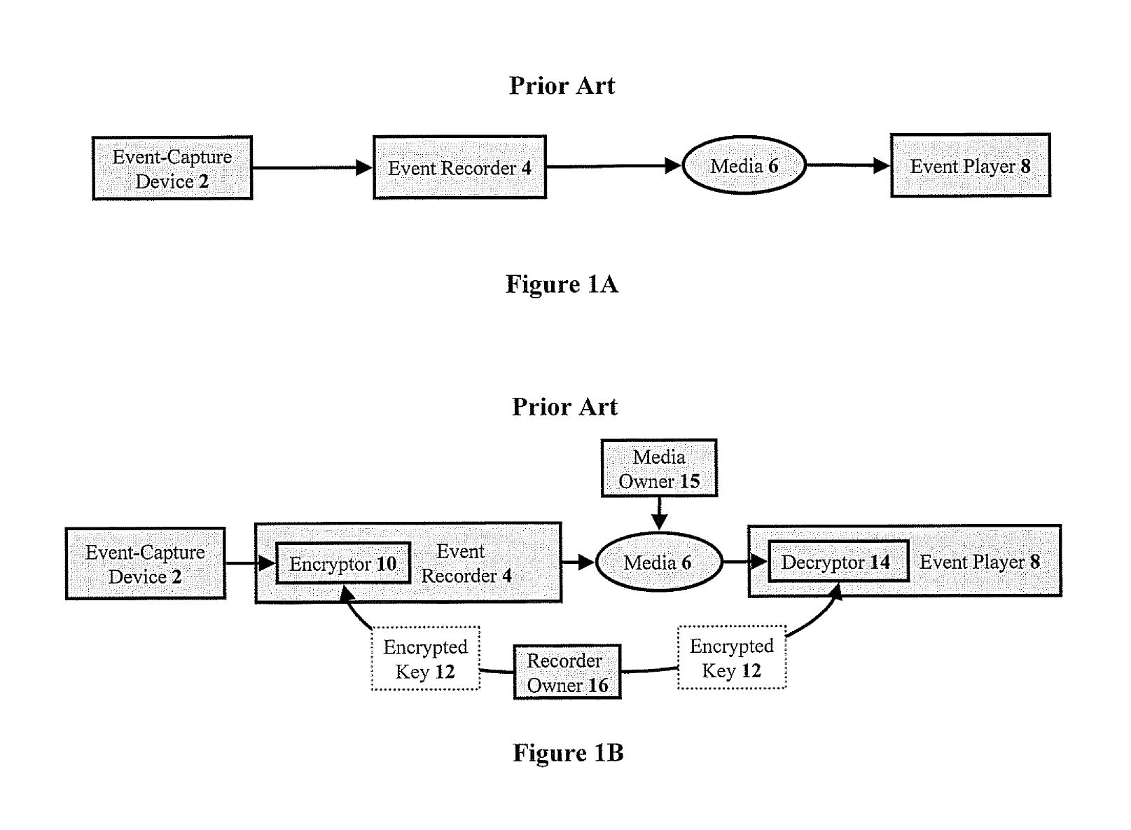

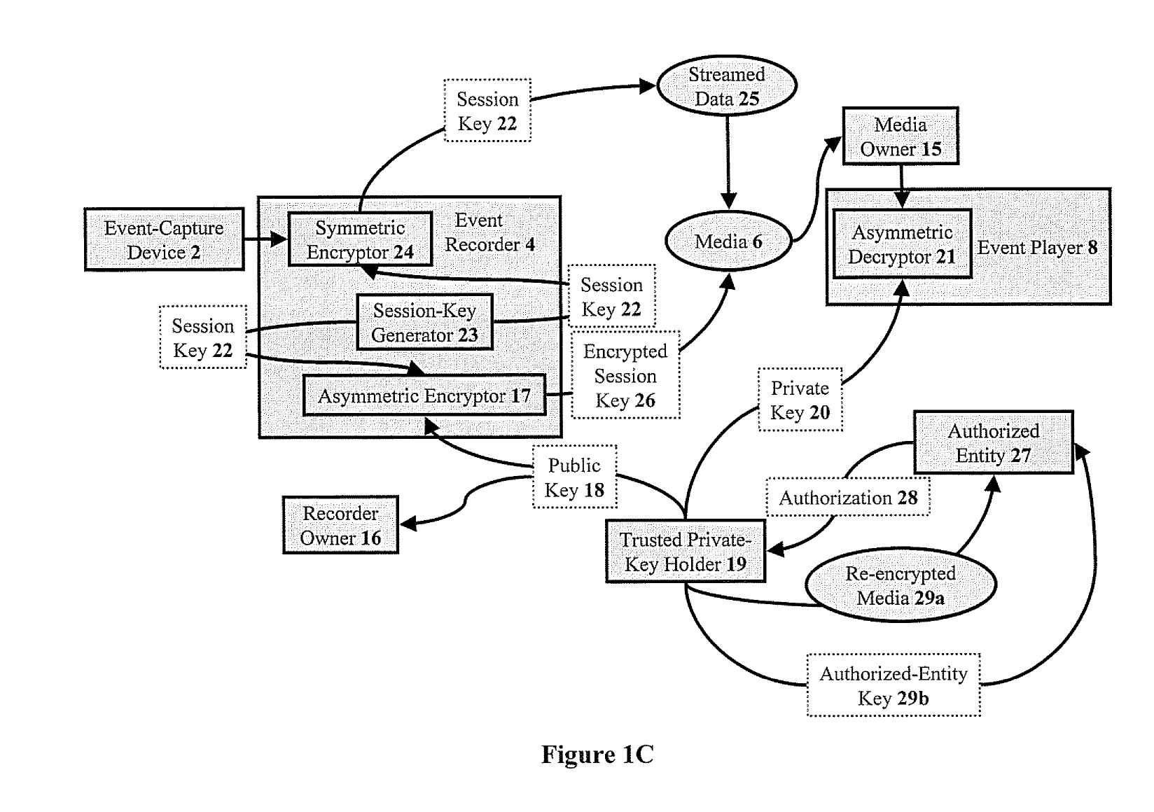

Referring now to the drawings, FIG. 1A is a schematic block diagram of a typical prior-art event recorder with no encryption mechanism. An event-capture device 2 (e.g. a microphone or a video camera) captures an event and sends it to an event recorder 4. Event recorder 4 typically converts the data received from event-capture device 2 into a standard format, which may be analog or digital, and stores the data in media 6. Typical media include magnetic tape, CD, hard disk, or non-volatile flash memory. At any time, media 6 can be connected to an event player 8 and played.

FIG. 1B is a schematic block diagram of a typical prior-art event recorder using a symmetric key for encryption of the recorded event. FIG. 1B incorporates into the scheme of FIG. 1A an encryptor 10, which is integrated into event recorder 4. Encryptor 10 encrypts the captured event (obtained from event-capture device 2) while recording onto event recorder 4 using an encrypted key 12. In order to play the recorded event, encrypted key 12 has to be provided to a decryptor 14 which is integrated into event player 8. A media owner 15 is the owner of media 6. A recorder owner 16 of event recorder 4 is also the owner of encrypted key 12.

FIG. 1C is a schematic block diagram of a one-way event recorder using asymmetric keys for encryption of the recorded event, according to a preferred embodiment of the present invention. In this embodiment, the encryption utilizes asymmetric keys. An asymmetric encryptor 17 uses a public key 18, supplied by a trusted private-key holder 19, for the encryption. In order to play the recorded event, a corresponding private key 20, also generated and maintained by trusted private-key holder 19, has to be used with an asymmetric decryptor 21.

A more detailed description of the recording scheme proceeds as follows. A session key 22 is generated by a session-key generator 23, and sent to a symmetric encryptor 24 in event recorder 4. Session key 22 is used to encrypt streamed data 25 which is then written (i. e. recorded) to media 6. Public key 18 is used by asymmetric encryptor 17 for encrypting session key 22. The encryption of session key 22 produces an encrypted session key 26, which is written to media 6 as part of the recorded event data. It is noted that the encrypting of session key 22 into encrypted session key 26 can occur either before or after the data has been written to media 6. For playing the data in media 6, private key 20 is used by trusted private-key holder 19 with an asymmetric decryptor 21 in event player 8. Playback of media 6 can only occur if an authorized entity 27 (e.g. a court) issues an authorization 28 (e.g. a court order) to trusted private-key holder 19 to decrypt media 6. Additionally and/or alternatively, decrypted media 6 can be delivered by trusted private-key holder 19 as re-encrypted media 29a, along with an authorized-entity key 29b, to authorized entity 27.

Typically, public key 18 is provided to recorder owner 16, and private key 20 is kept in a safe place by trusted private-key holder 19, and will only be used if certain conditions apply (e.g. a court order is issued). Practically, public key 18 is provided directly to event recorder 4, since public key 18 is only used for encryption. Public key 18 is a substantial data file, and not something that recorder owner 16 would typically memorize or type.

An example of how such an arrangement can be implemented is as follows. A manufacturer of event recorders, such as event recorder 4, requests that trusted private-key holder 19 provide public keys, such as public key 18, be installed on the event recorders, and that corresponding private keys, such as private key 20, be maintained by trusted private-key holder 19 for safekeeping. The event recorders are then sold with serial numbers designating that the recorders are certified, write-only recorders by trusted private-key holder 19.

Media 6 cannot be used to play the recorder event by media owner 15 because media owner 15 does not possess private key 20. Using such a recording scheme allows recorder owner 16 to record an event without breaking the law because recorded media 6 cannot be played by recorder owner 16, media owner 15, or by anyone else without authorization 28 from authorized entity 27.

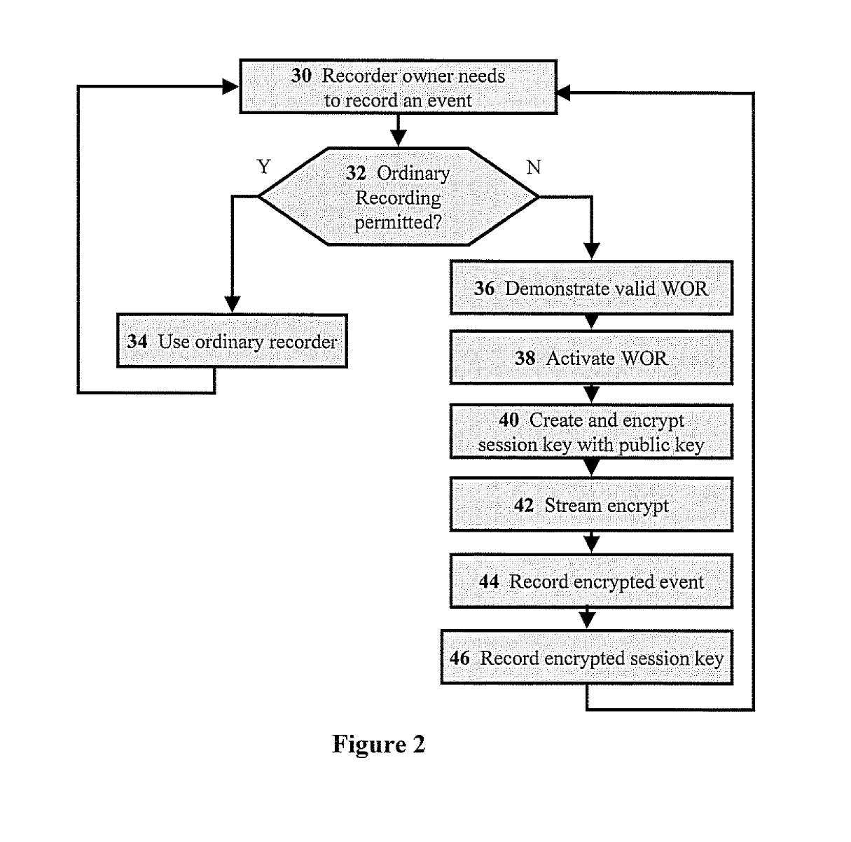

FIG. 2 is a simplified flowchart of the process of recording a write-only recorder (WOR) recorded event, according to a preferred embodiment of the present invention. Recorder owner 16 of a recording system (i.e. event-capture device 2 and event recorder 4), who needs to record an event (Block 30), checks if ordinary recording is permitted (Block 32). If ordinary recording is permitted, an ordinary recording system is used (Block 34). If an ordinary recording is not permitted, recorder owner 16 demonstrates, to the other parties (e.g. the party being recorded) who may object to the recording, that he/she has a valid write-only recorder (WOR) (Block 36). Demonstration that recorder owner 16 has such a valid WOR can be performed, for example, by presenting a certified WOR. The WOR is activated (Block 38), and session key 22 is generated and encrypted using public key 18 to produce encrypted session key 26 (Block 40). The event is captured and symmetrically encrypted with session key 22 (Block 42), and then the event is recorded onto media 6 (Block 44). Finally, encrypted session key 26 is recorded onto media 6 (Block 46).

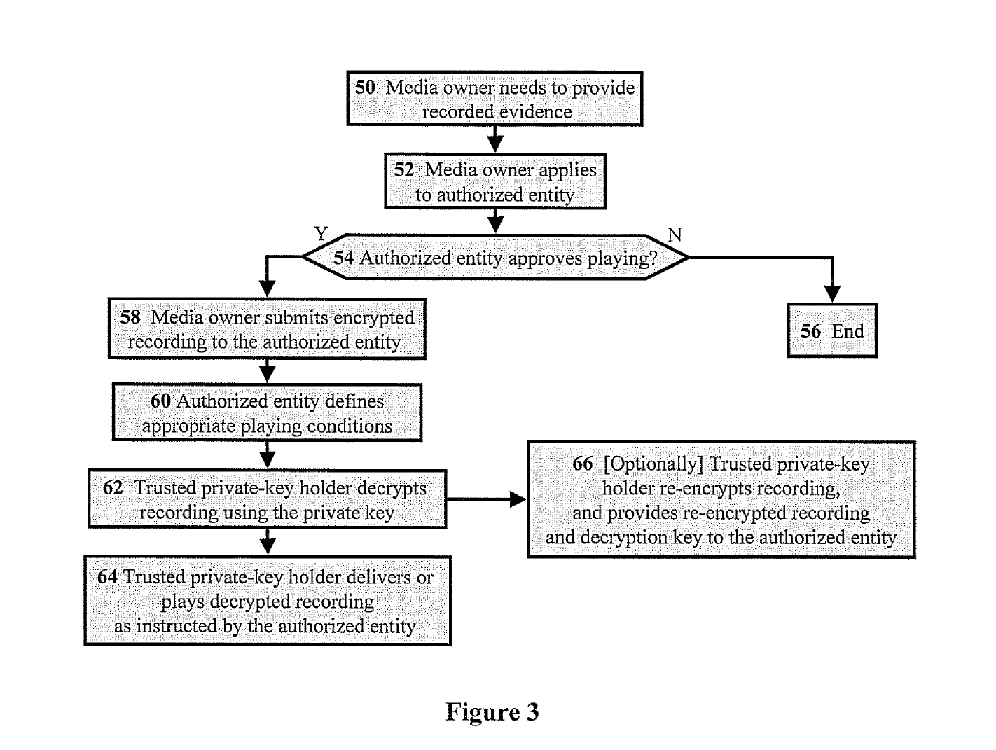

FIG. 3 is a simplified flowchart of the process of playing a WOR-recorded event, according to a preferred embodiment of the present invention. If media owner 15 has justification for playing the recorded event (Block 50), he/she applies to authorized entity 27 to ask for permission to play the recorded event (Block 52). Authorized entity 27 checks the justification (Block 54), and either rejects (Block 56) or approves the justification. If the recorded event is approved for playing, media owner 15 submits encrypted media 6 (containing the recorded event) to authorized entity 27 (Block 58). Authorized entity 27 defines the appropriate playing conditions (e.g. a closed room where only approved individuals are allowed) (Block 60). Upon receiving authorization 28, trusted private-key holder 19 decrypts media 6 using private key 20 with asymmetric decryptor 21 (Block 62), and delivers or plays the recorded event on event player 8 as instructed (Block 64). Additionally and/or alternatively, decrypted media 6 can be delivered by trusted private-key holder 19 as re-encrypted media 29a, along with an authorized-entity key 29b, to authorized entity 27 (Block 66).

While the invention has been described with respect to a limited number of embodiments, it will be appreciated that many variations, modifications, and other applications of the invention may be made.

What is claimed is:

1. A recording system for securely recording an event, the system comprising:
(a) a capturing device for an owner to capture signals from the event, and for converting said signals into digital data;
(b) a public-key encrypting mechanism, configured to use a public key of an asymmetric key-pair, for encrypting said data into encrypted data;
(c) a non-volatile storage device for storing said encrypted data; and
(d) a private-key decrypting mechanism, configured to use a private key of said asymmetric key-pair, for decrypting said encrypted data stored in said storage device only upon using said private key, wherein said private key is securely maintained with a trusted private-key holder, and wherein said trusted private-key holder is at least one entity other than said owner of said capturing device.

2. The system of claim 1, wherein said capturing device includes at least one device selected from the group consisting of: a camera, a microphone, a video recorder, and an audio recorder.

3. The system of claim 1, wherein said public key is provided by said trusted private-key holder to said encrypting mechanism.

4. The system of claim 1, wherein said trusted private-key holder is operative to decrypt said encrypted data only upon receiving an authorization from an authorized entity.

5. The system of claim 4, wherein said trusted private-key holder is operative to re-encrypt said encrypted data, after being decrypted using said private key, and to provide re-encrypted data and an authorized-entity key to said authorized-entity.

6. The system of claim 4, wherein said authorized entity is at least one entity other than said owner of said capturing device.

7. The system of claim 1, wherein said storage device is a flash memory device.

8. The system of claim 1, wherein said capturing device, said encrypting mechanism, and said storage device are housed in a single housing.

9. A method for securely recording an event, the method comprising the steps of:
(a) capturing signals from the event in a capturing device by an owner;
(b) converting said signals to digital data in said capturing device;
(c) encrypting said data using a public-key encrypting mechanism, configured to use a public key of an asymmetric key-pair, for encrypting said data into encrypted data;
(d) storing said data after encryption in a storage device; and
(e) decrypting said data, using a private-key decrypting mechanism, configured to use a private key of said asymmetric key-pair, for decrypting said encrypted data stored in said storage device only upon using said private key, wherein said private key is securely maintained with a trusted private-key holder, and wherein said trusted private-key holder is at least one entity other than said owner of said capturing device.

10. The method of claim 9, wherein said capturing device includes at least one device selected from the group consisting of: a camera, a microphone, a video recorder, and an audio recorder.

11. The method of claim 9, wherein said public key is provided by said trusted private-key holder to said encrypting mechanism.

12. The method of claim 9, wherein said trusted private-key holder is operative to decrypt said encrypted data only upon receiving an authorization from an authorized entity.

13. The method of claim 12, wherein said trusted private-key holder is operative to re-encrypt said encrypted data, after being decrypted using said private key, and to provide re-encrypted data and an authorized-entity key to said authorized-entity.

14. The method of claim 12, wherein said authorized entity is at least one entity other than said owner of said capturing device.

15. The method of claim 9, wherein said storage device is a flash memory device.

16. The method of claim 9, wherein said capturing device, said encrypting mechanism, and said storage device are housed in a single housing.
